(19) United States
(12) Patent Application Publication
(10) Pub. No.: US 2011/0023452 A1
(43) Pub. Date: Feb. 3, 2011

(54) APPARATUS FOR TREATING AN EXHAUST GAS STREAM WITH REMOVABLE MODULE

(75) Inventors: Thomas Gisslen, Goteborg (SE); Mikael Jonson, Onsala (SE); Johan Land, Satila (SE); Annika Isaksson, Goteborg (SE); Johan Bengtsson, Goteborg (SE)

Correspondence Address: HARNESS, DICKEY & PIERCE, P.L.C., P.O. BOX 8910, RESTON, VA, 20195, US

(73) Assignee: Swenox AB, Vastra Frolunda (SE)

(21) Appl. No.: 12/736,477

(22) PCT Filed: Mar. 30, 2009
(86) PCT No.: PCT/EP2009/054654

§ 371 Date: Oct. 12, 2010

(30) Foreign Application Priority Data
Apr. 18, 2008 (EP) 08154787.9

(51) Int. Cl. F01N 1/00; B01D 51/08; B01D 46/00; B23P 19/00; B01D 53/34

(52) U.S. Cl. 60/272; 96/389; 55/483; 29/700; 422/168

(57) ABSTRACT

An apparatus for treating an exhaust gas stream and having removable module(s) is disclosed. The apparatus comprises a housing, providing fixed boundaries at least between an inlet and an outlet and at least two sections arranged within said housing, the housing defining an interior exhaust passage that extends sequentially through said sections, wherein one or more treatments are to be performed upon a gas flowing through said sections. At least one of said sections is removable from within the fixed boundaries of the housing in a direction essentially perpendicular to said flow direction. Further, there is provided first releasable clamping means securing a first end of said removable section to a first adjacent part both axially and radially and second releasable clamping means securing a second end of said removable section to a second adjacent part at least radially, wherein in a clamped position said second end is separated from said second adjacent part by a tolerance gap, and wherein said second releasable clamping means in the clamped position also provides a seal between said second end and said second adjacent part.

### FIELD OF THE INVENTION

The present invention relates to an apparatus for treating an exhaust gas stream from internal combustion engines for motor vehicles and other applications, said apparatus comprising at least one removable section. It also relates to a method for mounting a removable section of an apparatus for treating an exhaust gas stream.

### BACKGROUND OF THE INVENTION

Exhaust from diesel engines may contain a number of unwanted noxious gases, such as nitrogen oxides (NOₓ), carbon monoxide and un-burnt hydrocarbons; the exhaust may also contain particulate matters. The amount of those gases emitted from the engines is regulated by legal requirements. To be able to remove them, they can be treated so as to render them less obnoxious. This is made in an after treatment system, i.e. an apparatus for treating an exhaust gas stream.

It is therefore common practice to pass the exhaust gases through one or more treatment chambers of such an apparatus, containing e.g. a catalytic converter in which the unwanted noxious gases are converted to less harmful emissions. In the case of diesel engines the particulate matters are removed from the exhaust gas stream by a metal gauze or mesh or a ceramic filter element. The NOₓ and oxygen in the gas stream can react with the particulates trapped in the filter element to form for example carbon dioxide, which is then mixed with the other exhaust gases. The filtered gases can then be subjected to reduction of remaining nitrogen oxides to nitrogen gas by injecting a reducing agent such as a solution of urea into the gas stream after it leaves the filter element but before it leaves the silencer unit. The treated gas stream is then passed over a further catalyst to convert residual ammonia from the urea to nitrogen and water, which are acceptable exhaust emissions. The net result is a typical reduction in noxious components of the exhaust gases of over 90%.

In many applications, filtration treatment element needs to be removed from the apparatus, cleaned from residual ash stored in the filter and refitted. Other treatment elements may require replacement or servicing and different treatment elements may have different service intervals. It is therefore desirable to be able to remove at least some of the individual treatment elements such that they may be individually serviced without the need to substantially dismantle the gas treatment apparatus.

To this end, it is known to provide apparatuses for treating an exhaust gas stream comprising a housing with at least two sections, adapted for different forms of treatment of the exhaust stream, arranged within the housing, and wherein at least one of said sections is removable from within the housing. The sections are typically connected to each other by means of V-clamp straps provided at flange interfaces located adjacent opposite ends of the sections. Upon tightening of the V-clamps, the straps contract radially upon the terminal flanges of the sections, whereby the flanges are drawn axially towards each other, whereby the sections are locked together both radially and axially. By removing the end clamps, a removable section can be removed for servicing or replacement. Such or similar apparatuses are e.g. disclosed in WO 2006/029201 and EP 1 235 976. How often the filter, catalytic converter etc need to be removed for replacement or service depends on a number of parameters, such as the type of combustion engine used, how frequently the engine is operated, et c, but for normal heavy duty vehicles at least some of the treatment sections would need to be removed once or twice a year, or even more frequently.

However, several problems with these known apparatuses with removable sections still exist. For example, in many of these known devices it is still relatively complicated and cumbersome to mount and dismount the removable sections.

Further, it is often a need to arrange the apparatus between two fixed points in the vehicle, whereby all axial displacement of the sections must take place in the apparatus itself, between said fixed attachment points. It is also often necessary to remove the removable section in a direction essentially perpendicular to the gas flow direction, instead of in an axial direction. This makes it necessary to use complicated and expensive telescopically sliding arrangements or the like, or to allow only very small tolerances, which also makes the apparatus expensive and difficult to manufacture and assemble and reassemble. Use of two V-clamp straps, one in each end of the removable section implies that the removable section is drawn axially towards the adjacent part on each side, which is only possible if at least one of said adjacent part is axially displaceable. Further, these known apparatuses are often subject to very high temperatures, leading to significant heat elongation. Still further, it is often difficult to obtain adequate sealing in the connection between the removable section and other parts. Still further, many of the existing after treatment systems are relatively large and bulky, which is a disadvantage, since the present trend is to make all components of heavy vehicles as compact as possible.

There is therefore a need for an improved apparatus for treating an exhaust gas stream, which addresses at least some of the above-discussed drawbacks of the prior art.

### SUMMARY OF THE INVENTION

It is therefore an object of the present invention to provide an apparatus for treating an exhaust gas stream, and having at least one removable treatment section, which alleviates at least some of the above-discussed drawbacks of the prior art. Further, it is an object to provide a corresponding method for mounting a removable treatment section of such an apparatus.

This object is achieved with an apparatus and a method according to the appended claims.

According to a first aspect of the present invention there is provided an apparatus for treating an exhaust gas stream, the apparatus comprising:

a housing providing fixed boundaries at least between an inlet and an outlet;

at least two sections arranged within said housing, the housing defining an interior exhaust passage that extends sequentially through said sections, wherein one or more treatments are to be performed upon a gas flowing through said sections;

wherein at least one of said sections is removable from within the fixed boundaries of the housing in a direction essentially perpendicular to said flow direction;

first releasable clamping means securing a first end of said removable section to a first adjacent part both axially and radially; and

second releasable clamping means securing a second end of said removable section to a second adjacent part at least radially, wherein in a clamped position said second end is separated from said second adjacent part by a tolerance gap, and wherein said second releasable clamping means in the clamped position also provides a seal between said second end and said second adjacent part.

The term “section” or “treatment section” are used herein to describe units comprising filters, catalysts, acoustic units and the like that can be used to treat an exhaust gas stream. The term is used to include any surrounding padding and casing material such as shock absorbing padding or a metal casing that may be present surrounding the treatment element.

The housing provides a fixed boundary between an inlet connection and an outlet connection for the apparatus. The housing may be arranged to cover the intermediate sections. However, alternatively the sections may form part of the housing, wherein the housing is formed by the section walls and end-caps connected to the ends of said sections.

Due to this arrangement of the sequential and preferably co-axial sections, and due to the provision of the tolerance gap, the removable section is at least slightly shorter than the space available for it between the adjacent parts. Hereby, mounting and dismounting of the removable section becomes very simple, which renders the operation very effective. At the same time, the removable section is effectively secured to the adjacent parts, and provides a sufficient seal. Thus, the removable section can easily be removed from within the compartment body for replacement or servicing without moving or removing any one of the adjacent parts to which the removable section has been attached. All other elements of the apparatus which are not to be removed may therefore be permanently secured in place in the apparatus, which may give the apparatus greater strength or resilience to damage or deformation.

The first releasable clamping means secures the first end of the removable section to the adjacent part both axially and radially. Preferably, the first releasable clamping means in a clamped position sealingly clamps said first end in direct abutment with said first adjacent part. This may e.g. be achieved by means of a clamp strap with a substantially V-shaped cross-section, e.g. arranged around corresponding circumferential and radially outwardly extending flanges provided at the first end of the removable section and the first adjacent part. However, alternative first clamping means are feasible, such as bolt connections arranged through radially outwardly extending flanges provided at the first end of the removable section and the first adjacent part. Thus, the first clamping means holds the first end of the removable section securely in place, and the removable section is also allowed to be axially displaced towards the first adjacent part during the clamping process, as is discussed in more detail in the following.

The term “V-shaped” is here used as a common denominator for essentially all circumferential clamp straps having a concave inner shape, i.e. forming an annular groove in the side facing inwardly, thereby providing both a radial force and an axial force compressing the parts enclosed by the strap when the strap is tightened.

The second releasable clamping means secures the second end of the removable section to a second adjacent part at least radially, and extends over the tolerance gap separating the second end of the removable section and the second adjacent part, thereby providing a seal between these adjacent parts. Thanks to this arrangement, the apparatus is less sensitive to tolerances in the axial direction. For example, the length of the removable section may be allowed to vary to a certain degree, without affecting the possibility of sealingly connecting it to the other parts of the apparatus. Hereby, the precision in the manufacture of the removable section is less crucial, making the manufacturing easier and less costly. Further, the total axial length of the apparatus may still remain fixed at all times, making it possible to mount the apparatus between fixed points in the vehicle once and for all. Still further, the tolerance gap makes the mounting and dismounting of the removable section very simple, and also enables a continuous adjustment for length variations due to heat expansion when the apparatus is in use. Since the second clamping means primarily only has to provide radial fixation of the removable section, several ways of obtaining an adequate seal over the tolerance gap are feasible.

The second releasable clamping means is preferably a band clamp, which is a relatively simple and inexpensive structure, but yet provides adequate sealing and securing capacity. Further, the second end of said removable section and a corresponding end of said second adjacent part are preferably provided with corresponding cylindrical connection sections with essentially identical diameters, making the band clamps easier to mount, and the connection by means of the band clamp more effective.

The band clamp preferably comprises a band of a width sufficient to cover the tolerance gap and of a length exceeding the outer circumference of the sections to be connected, thereby providing an overlap of the band. Further, it is preferred that in the end of the band to be facing the sections to be adjoined, the band is beveled and provided with a smaller thickness, and preferably with a thickness decreasing towards the end of the band. The band clamp may also comprise at least two separate tensioning means arranged on top of the bottom band. Still further, a gasket of a compressible material may be arranged underneath the second releasable clamping means.

Each end of the removable section may be connected to either an end cap, another treatment section, or to any other structure present within the apparatus, However, preferably the first end of the removable section is connected to an end cap, and the second end is preferably connected to another treatment section. Hereby, the tolerance gap becomes situated closer to the centre of the apparatus, which makes the above-discussed advantages of it more pronounced.

The removable section are preferably tubular, and comprises treatment elements such as e.g. a catalytic converter, a filter and/or an acoustic unit, carried within the bore of the tubular member. Typically such tubular members contain a cylindrical core of the treatment element appropriate to the treatment which is to be carried out in that module of the exhaust treatment apparatus. Thus, one section will usually contain a cylindrical core of a through-flow porous or apertured ceramic support (which may also act as a filter) carrying the catalyst dip coated or vapour deposited within the gas flow passages thereof; and another will contain a filter core having a plurality of axial bores closed at alternate ends so as to provide a tortuous path for gas through the filter element. Such cores, their design and manufacture can be of conventional nature, and are per se well-known in the art. The cores are typically surrounded by a shock absorbing material, and by a cylindrical steel tubular wall or the like. The removable section is preferably reusable after removal, but disposable sections are also feasible.

It is possible to provide only one removable section within the apparatus. However, it is also possible to provide at least two removable sections. In such an arrangement, the two removable sections are preferably arranged adjacent to each other, whereby the second releasable clamping means is arranged between the second ends of said adjacent removable sections, thereby providing said tolerance gap between said two removable sections

The tolerance gap may e.g. be in the range 1-25 mm, and preferably in the range 3-20 mm, and most preferably in the range 5-12 mm.

In the clamped position, the second releasable clamping means preferably provides a seal between said second end and said second adjacent part leaking less than 50 litre/minute at 0.3 bar internal pressure, and preferably less than 30 litre/minute, and most preferably less than 25 litre/minute.

The sections connected by means of the first clamping means and/or the second clamping means at least at the ends preferably have a rounded cross-section, and preferably a circular, elliptical, super-elliptical or oval cross-section. This makes e.g. strap connections more effective and easier to tighten properly.

In order to obtain even better gas sealing properties, it is possible to provide a gasket between the first end of the removable section and the adjacent part, and/or between the second releasable clamping means and the second end of the removable section and the adjacent part. The gaskets are preferably annular gaskets, and may be made from rubber, a ceramic string or braid, and possibly impregnated with graphite, or other deformable thermally stable materials.

The present invention is of especial application in the treatment of the exhaust gases from internal combustion engines, notably diesel or spark ignition engines. With such exhaust gas streams, a series of treatments can be carried out using the nature of the contaminants in the exhaust gases to form reagents in the gas stream which can be used to eliminate or reduce other contaminants in a subsequent treatment. The engine may be a stationary engine, for example driving an electricity generator or an hydraulic fluid compression unit, or a marine engine. However, the invention is of especial application in the treatment of the exhaust gases from a diesel engine in a modular silencer assembly on a motor vehicle to attenuate the engine noise and to reduce the noxious emissions from the engine as described above. For convenience, the invention will primarily be described in terms of such a preferred use.

In a preferred embodiment, there is further provided a sensor which extends into the exhaust gas stream, the sensor in the clamped position being arranged to extend into the tolerance gap. Additionally or alternatively, the sensor may, in the clamped position, be arranged on or adjacent to the second releasable clamping means. Hereby, it becomes possible to monitor properties of the exhaust gas stream, such as temperature, pressure and contents of the gas, e.g. the amount of NOₓ, without the need for any additional measuring volume in the apparatus. Hereby, a very efficient overall design may be obtained, which optimizes the length requirements and allows larger substrate volumes. Several sensors may also be provided in this way. The sensor may be arranged through the second releasable clamping means, such as the band clamp, and connected to the wall of said clamp. Alternatively, or additionally, a sensor may be arranged through and connected to the walls of one of the sections adjacent to the tolerance gap, whereby a corresponding cutout may be provided in the second releasable clamping means.

According to another aspect of the present invention there is provided a vehicle comprising a gas treatment apparatus for the treatment of an exhaust gas stream from an internal combustion engine, the gas treatment apparatus being of the type discussed in the foregoing.

According to still another aspect of the present invention, there is provided a method of mounting a removable section of an apparatus for treating an exhaust gas stream, the apparatus comprising a housing providing a fixed boundary between at least an inlet and an outlet, and with at least two sections arranged within said housing, the housing defining an interior exhaust passage that extends sequentially through said sections, wherein one or more treatments are to be performed upon a gas flowing through said sections, said method comprising the steps:

securing a first end of said removable section to a first adjacent part both axially and radially; and

securing a second end of said removable section to a second adjacent part at least radially, wherein in a secured position said second end is separated from said second adjacent part by a tolerance gap, and wherein said tolerance gap is sealed against leakage.

In accordance with this aspect of the invention, similar advantages as discussed above with reference to the first aspect of the invention are obtainable.

The steps of securing the first end and securing the second end of the removable section may be performed in arbitrary order. However, preferably the first end is secured first, and the second end subsequently, since this will allow the removable section to move freely during the clamping of the first clamping means. However, the reverse order is also possible. As a further alternative, the second clamping means may be loosely attached at first, and thereafter the first clamping means can be arranged in position and tightened. Finally, the second clamping means is tightened.

These and other aspects of the invention will be apparent from and elucidated with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic cross-sectional view of an exhaust treatment apparatus in accordance with one embodiment of the present invention;

FIG. 2 is a perspective view from the side of the apparatus of FIG. 1, where the compartment body is in an opened disposition, and with part of the compartment body being cut-out;

FIG. 3 is an illustration of a part of a V-shaped strap for securing one end of a removable section of the apparatus of FIG. 1;

FIG. 4 is an illustration of a part of a band strap for securing another end of a removable section of the apparatus of FIG. 1;

FIG. 5 is a further illustration of the apparatus of FIG. 1, where a removable section is being dismounted;

FIG. 6 is a cross-sectional view of a part of the apparatus of FIG. 1, illustrating an arrangement with a small tolerance gap;

FIG. 7 is an illustration of the same view as in FIG. 6, but illustrating a larger tolerance gap;

FIG. 8 is a cross-sectional view of a part of the apparatus of FIG. 1, but with a sensor provided in the vicinity of the band clamp; and

FIG. 9 is the same view as in FIG. 8, illustrating an alternative arrangement of the sensor.

### DESCRIPTION OF PREFERRED EMBODIMENTS

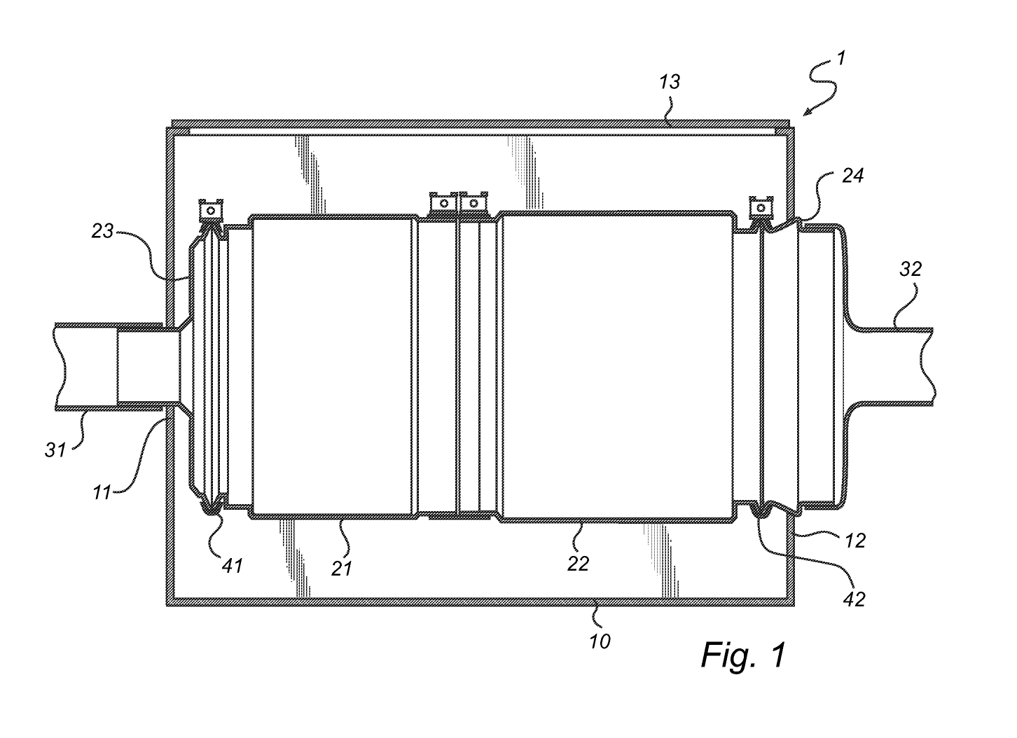

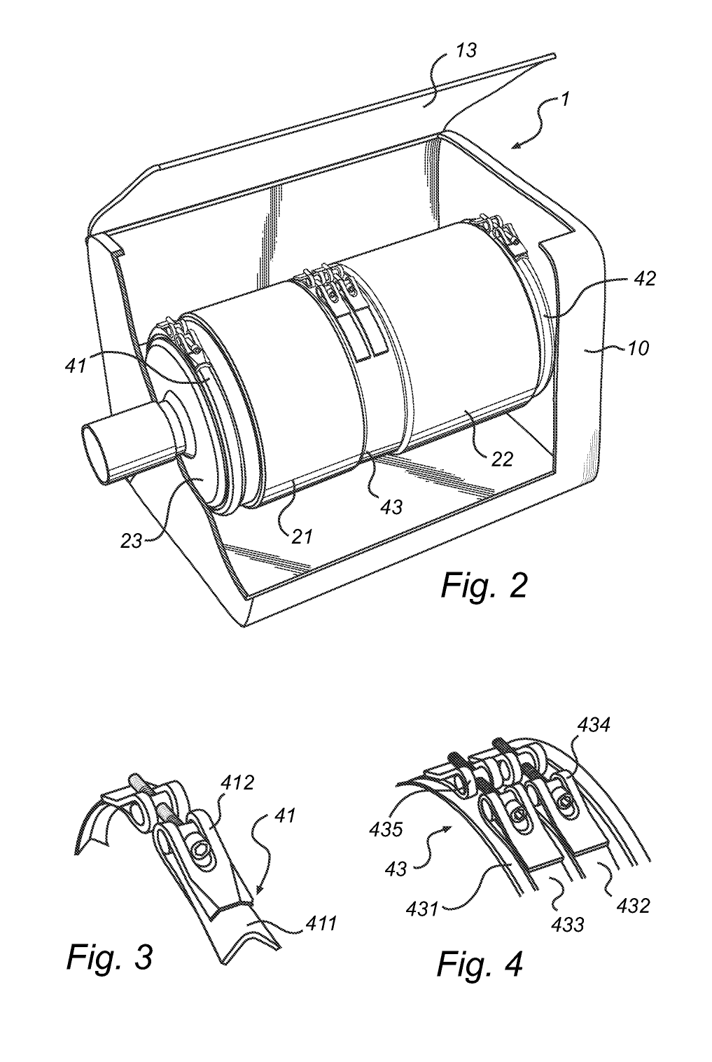

With reference to FIGS. 1 and 2, the invention generally relates to an apparatus 1 for treating an exhaust gas stream, for use in e.g. heavy duty vehicles. The apparatus comprises a housing 10, forming a protective enclosure in which the exhaust treatment element are arranged. The housing 10 comprises holes 11, 12 in which the exhaust stream are to enter, e.g. arranged at side-walls of the body. Further, the housing is openable, for rendering easy access to the interior during maintenance services. To this end, the housing is provided with a door or cover 13, which may e.g. be hinged to one side of the maintenance opening. However, the protective enclosure is optional, and the housing may also be formed by the outer walls of the treatment sections and end-caps connected to these sections.

In the interior of the housing 10 a plurality of treatment sections are arranged, providing one or more channels in which the exhaust stream are to flow during execution of the treatment steps. In the illustrative example, the apparatus comprises two treatment sections 21, 22 arranged inside the housing 10, and two end-caps 23, 24, each connected to an end of the treatment sections, and extending through the holes 11, 12 in the housing 10. The ends of the end-caps projecting out from the housing are fixedly connected to tube components 31, 32 of the exhaust system. In order not to becloud the description of the invention, only two treatment sections are used in the illustrative example. However, it should be appreciated that many more sections may be used, and that the sections may also be arranged in more complex channel arrangements.

Within the sections 21, 22 are located treatment elements (not shown) for treating a gas stream passing through said elements, as is per se previously known.

In the present example, an inlet tube connection 31 of the exhaust system is connected to a first end-cap 23, which in turn is connected to a first end of the first treatment section 21. The second end of the treatment section 21 is connected to a second end of the second treatment section 22, whereas the first end of the second treatment section 22 is connected to the second end-cap 24. The second end-cap 24 is connected to an outlet tube connection 32 of the exhaust system. The sections thereby defines an interior exhaust passage through the housing, extending sequentially through the sections, wherein one or more treatments is performed upon a gas flowing through the sections. Typically, one section may comprise a catalyst and another section a filter. However, other types of treatment elements are also feasible.

The connections between the end-caps 23, 24 and the inlet and outlet tube connections 31, 32 may be permanent fixed connections of conventional types, as are per se known in the art. The housing 10 provides fixed boundaries between said fixed connections, and by means of the present apparatus, these connections may remain fixed and attached also during removal and replacement of the removable sections, as is discussed in more detail in the following.

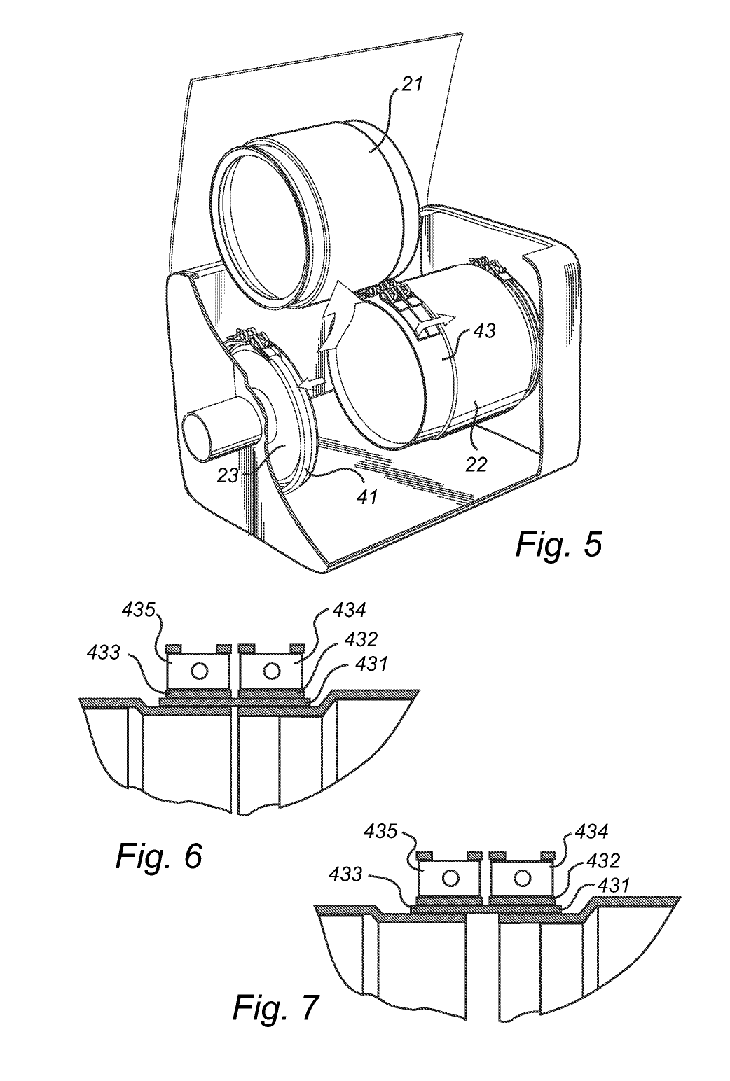

In the present example, both sections 21, 22 are removable. However it is to be appreciated by someone skilled in the art that alternatively, only one of the sections may be removable. Further, if more than two sections are provided, it is also feasible to make more than two sections removable. The removable sections are removable from within the housing in a direction essentially perpendicular to said flow direction, i.e. in an essentially radial direction. Removal of one of the sections is illustrated in FIG. 5, which is discussed in greater detail in the following.

The first end-cap 23 and the first end of the first treatment section 21 are connected to first releasable clamping means securing the ends both axially and radially in relation to each other. A gasket (not shown) may be arranged between the first end of the treatment section 21 and the first end-cap 23, in order to be compressed between these adjacent parts upon tightening of the first releasable clamping means. The clamping means is in this example a clamp strap 41 with a substantially V-shaped cross-section, arranged around corresponding circumferential and radially outwardly extending flanges provided at the ends of the end-cap and the treatment section. However, alternative first clamping means are feasible, such as bolt connections arranged through radially outwardly extending flanges provided at the terminal ends.

As best seen in FIG. 3, the clamp strap 41 of the present embodiment preferably comprises a band with a substantially V-shaped cross-section, with the concave surface facing the parts to be adjoined. Further, tensioning means, such as a bolt connection 412, connects the ends of the band, and are operable to increase and increase the tension of the band.

The second end-cap 24 and the first end of the second treatment section 22 may be connected by a similar clamping means, such as by another V-shaped strap 42, securing the ends both axially and radially in relation to each other.

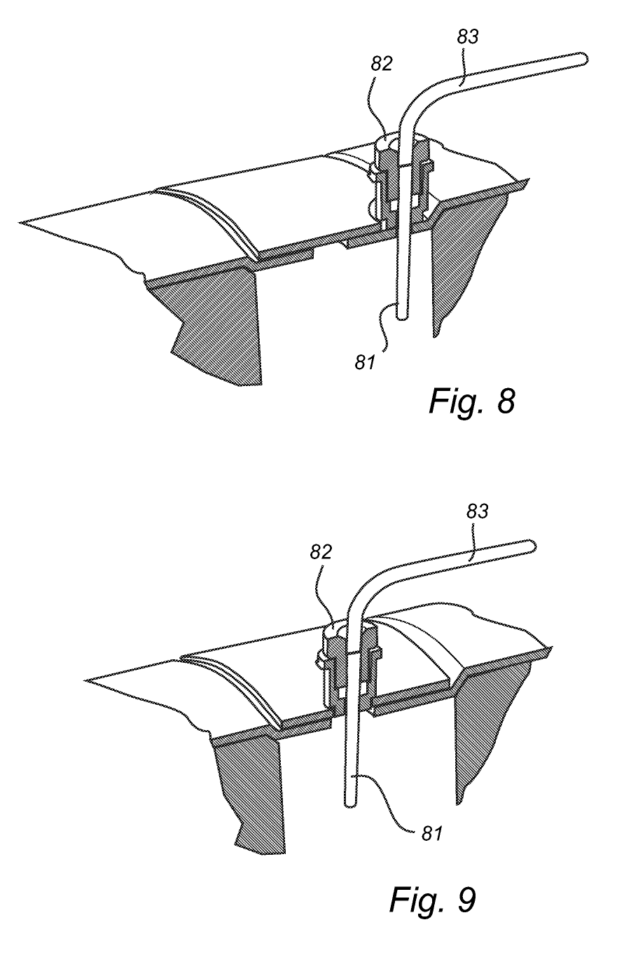

The connection between the second ends of the removable treatment sections 21, 22 is provided through second releasable clamping means, securing the sections at least radially. Further, a tolerance gap is provided between the section ends in the clamped position, wherein the clamping means in the clamped position extends over the tolerance gaps and provides a seal between the second ends of the adjacent sections. The tolerance gap may e.g. be in the range 1-25 mm, and preferably in the range 3-20 mm, and most preferably in the range 5-12 mm. FIG. 6 and FIG. 7 illustrates the clamping means arranged over a narrow tolerance gap and a wider tolerance gap, respectively.

The second releasable clamping means is in this example a band clamp 43. As best seen in FIGS. 4, 6 and 7, the band clamp 43 preferably comprises a bottom band 431, of a width sufficient to cover the tolerance gap, and to extend into both of the adjacent sections to be connected. The band further preferably has a length exceeding the outer circumference of the sections to be connected, thereby providing an overlap of the bottom band 431. In the end of the band intended to be underneath the other end of the band in the overlap area, i.e. in the end of the band to be facing the sections to be adjoined, the band is further preferably beveled and provided with a smaller thickness, and preferably with a thickness decreasing towards the end of the band. Hereby, a gas tight seal may be obtained even in the overlap area. Alternatively or additionally, a gasket (not shown) of a compressible material may be arranged between the bottom band 431 and the sections to be adjoined, either around the whole circumference, or only at certain parts, such as in the overlap area. The bottom band is preferably made of a single strip of metal, e.g. stainless steal, and has a thickness small enough to allow the band to form in correspondence with the supporting walls when tightened. However, other ways of forming the band are also feasible, e.g. by means of braided wires.

For enabling tensioning of the band clamp, there is further preferably provided two separate pair of tensioning band connections 432, 433 arranged on top of the bottom band. The tensioning band connections preferably have widths smaller than half the width of the bottom band, and preferably significantly smaller than said width of the bottom band, and extend on each side of an opening of the bottom band. Further, the tensioning band connections are preferably separated in the width direction, in order to bear on the end of section 21 and the end of section 22, respectively. Each pair of tensioning band connections 432, 433 are connected through tensioning means 434, 435, respectively, which are operable to increase or decrease the tensioning of the tensioning band connections. The tensioning means may be bolt connections connected through the ends of the tensioning bands, as illustrated in the attached drawings. However, any suitable tensioning means could be used, as would be apparent for someone of ordinary skill in the art. For example, tension may be applied by means of screws, nuts or bolts which secure the ends of straps; by twisting adjacent straps together; by applying a transverse force to the straps, for example by pulling them sideways to attach to hooks on the exposed wall of the sections in a manner similar to that used to tension a drum skin; by wedges or other means. Alternatively, the straps can be tensioned by an over-centre tensioning device, by the use of tension springs in the mounting and/or securing of the straps, or by applying the straps hot and allowing them to cool and contract once in situ.

Typically, the band clamp may have a total width, equal to the width of the bottom band, in the range in the range 2-10 cm, and preferably in the range 3-7 cm, and most preferably around 5 cm. The width of the tension band connections is preferably about a third of the total width. The thickness of the bottom band is preferably in the range 0.5-2 mm, and preferably in the range 0.6-1.2, and most preferably around 0.7 mm.

In the clamped position, the second releasable clamping means preferably provides a seal, with or without the provision of a gasket, between said second end and said second adjacent part leaking less than 50 liter/minute at 0.3 bar internal pressure, and preferably less than 30 liter/minute, and most preferably less than 25 liter/minute.

The second ends of the removable sections are preferably provided with corresponding cylindrical connection sections with essentially identical diameters, making the band clamps easier to mount, and the connection by means of the band clamp more effective. Further, the diameter of these end shoulders may be slightly smaller than the maximum diameter of the sections, thereby limiting or avoiding protrusion of the band strap. However, the diameter of the end shoulders may also be equal to the maximum diameter of the sections.

Referring now to FIG. 5, mounting and dismounting of the removable sections will now be discussed in more detail. For dismounting one of the removable sections, e.g. section 21, the door 13 of the compartment is first opened. Thereafter, the band strap 43 is loosened and displaced onto the adjacent section 22, and the V-clamp strap 41 is loosened and displaced onto the end-cap 23. The straps 41, 43 can be released in any order. When the straps are loosened and removed from the section 21 to be removed, the section can be pulled out radially.

Mounting of a new section is performed in about the same way, but in the reverse order. The straps 41, 43 are first loosened and removed onto the adjacent parts. Thereafter, the section 21 is put into place, and secured. Securing the section in place can e.g. be made by first arranging the band clamp 43 in the right position, and loosely tightening it. Thereafter the V-clamp strap 41 is arranged in place and tightened, and finally the band clamp 43 is tightened. However, this exact order is not imperative, and the arrangement and tightening of the straps may be conducted in any order.

In an apparatus for treating an exhaust gas stream it is often advantageous to arrange one or more sensor(s) in contact with the exhaust gas stream, for supervision and/or automated control. For example, it is often advantageous to have a temperature sensor for monitoring the current temperature of the exhaust gas stream, and/or a pressure sensor for monitoring the current pressure within the system. A sensor may also be provided to monitor the contents of the exhaust gas stream, and e.g. to monitor the amount of NOₓ in the gas. However, a problem associated with the use of such sensors has previously been that the arrangement of the sensors requires the addition of a separate volume for the sensor, and consequently an increased packaging space and an increased length of the overall system.

However, by means of the above-discussed apparatus for treating an exhaust gas stream, it is possible to arrange the sensor in the tolerance gap provided between the removable section and the adjacent part. Hereby, no additional space need to be assigned to the part of the sensor extending into the exhaust gas stream. Such arrangements are illustrated in FIGS. 8 and 9. The sensor preferably comprises a part 81 extending into the exhaust gas stream, such as a probe, a part 82 being arranged on the exterior, and a connection cable 83 for forwarding the measured signal to a control unit (not shown).

In the arrangement of FIG. 8, the sensor is connected with one of the sections of the apparatus, i.e either the removable section 21 or the adjacent section 22. The sensor may be connected to the wall by means of a bolt arrangement, or any other suitable connection means. Further, a corresponding cutout portion is preferably formed in the second resealable clamping means 43, i.e. the band clamp. Hereby, the sensor may operate in the tolerance gap provided between the sections, without any additional space being needed, and the band clamp may still be used in the same way as discussed above.

In an alternative arrangement, illustrated in FIG. 9, the sensor is instead connected to and arranged through the band clamp. Hereby, the sensor becomes automatically arranged within the tolerance gap, without any need for cutouts in the band clamp.

It is to be appreciated by someone skilled in the art, that even though the above-discussed example only comprises two sections, the apparatus may comprise any number of sections, arranged either in sequence or in parallel, and even though the present embodiment only comprises one channel for the exhaust stream, the channel may be branched into several parallel channels inside the apparatus, or the apparatus may comprise several totally separated channels. Further, instead of being co-axially arranged along a single line, as in the illustrative example provided here, the channel may also comprise turns, whereby the channel may be arranged to allow the stream to go back and forth within the apparatus. In such arrangements, it is also possible to have the holes 11, 12 of the housing 10 arranged on the same side, instead of on opposite sides as in the present example.

Further, the first and second releasable clamping means may take many different forms, as discussed briefly in the foregoing, and may be arranged on either side of the removable section. Further, the sections may comprise any type of treatment element for treating exhaust gas streams, as is per se known in the art.

Such and other obvious modifications must be considered to be within the scope of the present invention, as it is defined by the appended claims. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements. Further, a single unit may perform the functions of several means recited in the claims.

1. Apparatus for treating an exhaust gas stream, the apparatus comprising:
a housing, providing fixed boundaries at least between an inlet and an outlet;
at least two sections arranged within said housing, the housing defining an interior exhaust passage that extends sequentially through said sections, wherein one or more treatments are to be performed upon a gas flowing through said sections;
wherein at least one of said sections is removable from within the fixed boundaries of the housing in a direction essentially perpendicular to said flow direction;
first releasable clamping means securing a first end of said removable section to a first adjacent part both axially and radially; and
second releasable clamping means securing a second end of said removable section to a second adjacent part at least radially, wherein in a clamped position said second end is separated from said second adjacent part by a tolerance gap, and wherein said second releasable clamping means in the clamped position also provides a seal between said second end and said second adjacent part; wherein said second releasable clamping means is a band clamp with a width sufficient to cover the tolerance gap, and to extend into both the removable section and the second adjacent part, said band clamp in the clamped position being arrangeable over both said removable section and the second adjacent part, thereby securing them radially.

2. The apparatus of claim 1, wherein said first releasable clamping means in a clamped position sealingly clamps said first end in direct abutment with said first adjacent part.

3. The apparatus of claim 1, wherein said second end is connected to another of said at least two sections.

4. The apparatus of claim 1, wherein said first end is connected to an end cap.

5. The apparatus of claim 1, wherein said first releasable clamping means is a substantially V-shaped strap, and wherein the first end of said removable section and a corresponding end of said first adjacent part preferably are provided with corresponding circumferential and radially outwardly extending flanges.

6. The apparatus of claim 1, wherein the band clamp comprises a band of a width sufficient to cover the tolerance gap and of a length exceeding the outer circumference of the sections to be connected, thereby providing an overlap of the band.

7. The apparatus of claim 6, wherein in the end of the band to be facing the sections to be adjoined, the band is beveled and provided with a smaller thickness, and preferably with a thickness decreasing towards the end of the band.

8. The apparatus of claim 6, wherein the band clamp further comprises at least two separate tensioning means arranged on top of the bottom band.

9. The apparatus of claim 1, wherein the second end of said removable section and a corresponding end of said second adjacent part are provided with corresponding cylindrical connection sections with essentially identical diameters.

10. The apparatus of claim 1, wherein said at least one removable section is a catalyst, a filter and/or an acoustic unit.

11. The apparatus of claim 1, wherein the tolerance gap is in the range 1-25 mm, and preferably in the range 3-20 mm, and most preferably in the range 5-12 mm.

12. The apparatus of claim 1, wherein in the clamped position the second releasable clamping means provides a seal between said second end and said second adjacent part leaking less than 50 litre/minute at 0.3 bar internal pressure, and preferably less than 30 litre/minute, and most preferably less than 25 litre/minute.

13. The apparatus of claim 1, further comprising a sensor extending into the exhaust gas stream, said sensor in the clamped position being arranged to extend into said tolerance gap.

14. The apparatus of claim 1, further comprising a sensor extending into the exhaust gas stream, said sensor in the clamped position being arranged on or adjacent to the second releasable clamping means.

15. A vehicle comprising a gas treatment apparatus for the treatment of an exhaust gas stream from an internal combustion engine, the gas treatment apparatus being as claimed in claim 1.

16. Method of mounting a removable section of an apparatus for treating an exhaust gas stream, the apparatus comprising a housing providing fixed boundaries between an inlet and an outlet, and with at least two sections arranged within said housing, the housing defining an interior exhaust passage that extends sequentially through said sections, wherein one or more treatments are to be performed upon a gas flowing through said sections, said method comprising the steps:
securing a first end of said removable section to a first adjacent part both axially and radially; and
securing a second end of said removable section to a second adjacent part at least radially, wherein in a secured position said second end is separated from said second adjacent part by a tolerance gap, and wherein said tolerance gap is sealed against leakage, wherein said step comprises securing a band clamp so that it extends over the tolerance gap and into both the removable section and the second adjacent part, thereby securing radially both said removable section and the second adjacent part in a clamped position.
